(19) United States
(12) Patent Application Publication
(10) Pub. No.: US 2008/0221963 A1
(43) Pub. Date: Sep. 11, 2008

(54) SYSTEM AND METHOD OF ACADEMIC TUTORING

(75) Inventors: Eric Altshule, Marina Del Rey, CA (US); Jamie Altshule, Marina Del Rey, CA (US)

Correspondence Address: KLEINBERG & LERNER, LLP, 2049 CENTURY PARK EAST, SUITE 1080, LOS ANGELES, CA, 90067, US

(73) Assignee: ACADEMIC SUCCESS, LLC, Marina Del Rey, CA (US)

(21) Appl. No.: 11/684,504

(22) Filed: Mar. 9, 2007

(51) Int. Cl. G06F 15/02

(52) U.S. Cl. 705/9

(57) ABSTRACT

A system and method for the management of an academic tutoring service provides a series of interfaces, each providing functionality useful to a different user category, for use in the organization and management of the academic tutoring process. Included is the ability to create schedules for students and tutors, automatic invoicing to parents and tutoring session report generation.

### BACKGROUND

1. Field of the Invention

The present invention relates to utilizing a global network to perform a number of tasks related to the organization of an academic tutoring service and more specifically a system and method of academic tutoring.

2. Description of the Related Art

There exist other systems and methods in the prior art whereby tutors may be found. There exist numerous other listing services and coordination services whereby tutors may be pre-screened and interviewed. There further exist numerous businesses made up of dedicated tutoring physical locations wherein organized tutoring or extracurricular learning may take place.

Internet software has been used, for example, to provide email updates as to upcoming due dates for various types of projects. The internet has also been used in the prior art to provide web sites whereby teachers and students may login for assignments or to form discussion groups regarding various subject matter.

However, in the prior art, no single software solution has provided a means whereby tutors may be assigned to particular students, students associated with parents, assignments and tests tracked, updated and edited by students, parents and teachers, tutoring time arranged and tracked, billing organized and invoices sent.

For these reasons, there exists a need. Currently there is no integrated system incorporating numerous elements all useful in conducting business as an academic tutoring service. This need is addressed by the present invention.

### SUMMARY OF THE INVENTION

According to the present invention a system and method of academic tutoring is provided. In a preferred embodiment of the present invention a system and method is implemented using internet-based software, for conducting numerous tasks associated with academic tutoring and academic tutoring services.

A website is implemented using web-enabled software, whereby an administrator may login to the website to create student, tutor and parent accounts. Once the accounts are created, each of the student, tutor and parents may also login to the site to view varying elements of the tutoring process depending on the access rights associated with the individual login.

The administrator may “assign” tutors to a particular student and the parents associated with that student. The tutor's schedule, availability and the like may be set by the tutor, subject to administrator review—the administrator may set the tutor's pay rate and the rate at which the tutor is billed to clients.

The students may login and create calendars of classes, assignments, important dates, milestone dates and tutoring sessions. They may then input the work product from and any grades or results received for these assignments and any work that has been done with or without a tutor.

The tutors may login to the site to comment upon work completed with one or more students, to set availability for tutoring sessions, to request pay settings, to schedule or reschedule a tutoring session. The tutor may also input comments about assignments or about a student generally that are unavailable to the student, but are accessible to the parents of the student. The comments may be subsequently included in an email to the parents of the student that is combined in an invoice for the relevant sessions.

The administrator may set pay levels, schedule events, view a master calendar including all relevant tutoring sessions, send emails to parents including or not including tutor comments or send email or hard-copy invoices based upon the various tutoring sessions completed since the last invoice period. The administrator may further add additional students, alter or amend profiles of any user and generally control access to relevant portions of the tutoring site software.

It is therefore an object of the present invention to overcome the limitations of the prior art by providing an integrated system and method for the management of tutors, students, tutoring sessions, tutor and student comments, calendaring of assignments and tests, billing and emailing invoices of tutoring sessions to clients.

The novel features which are characteristic of the invention, both as to structure and method of the operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 is a block diagram of the system of the present invention.

FIG. 2, made up of FIGS. 2A, 2B, 2C and 2E illustrate the menus of the present invention.

FIG. 3 is an administrator's web page for invoice data.

FIG. 4 is a report an invoice email page from the administrator.

FIG. 5 is a student to tutor assignment frame from the administrator.

FIG. 6 is a reports frame available to an administrator.

FIG. 7 is a calendar frame available to a tutor.

FIG. 8 is an edit subject frame available to a tutor.

FIG. 9 is an input subject details frame available to a tutor.

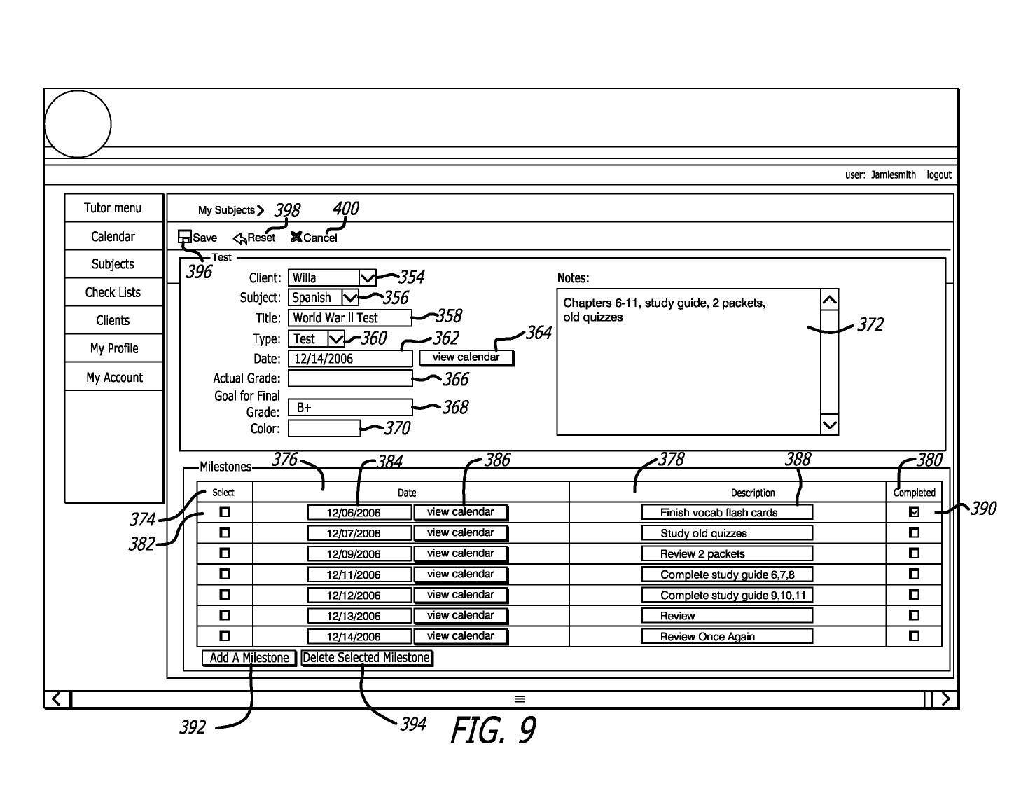

FIG. 10 is a client's sessions frame available to a tutor.

FIG. 11 is a flow diagram of the overall process.

### DETAILED DESCRIPTION OF THE INVENTION

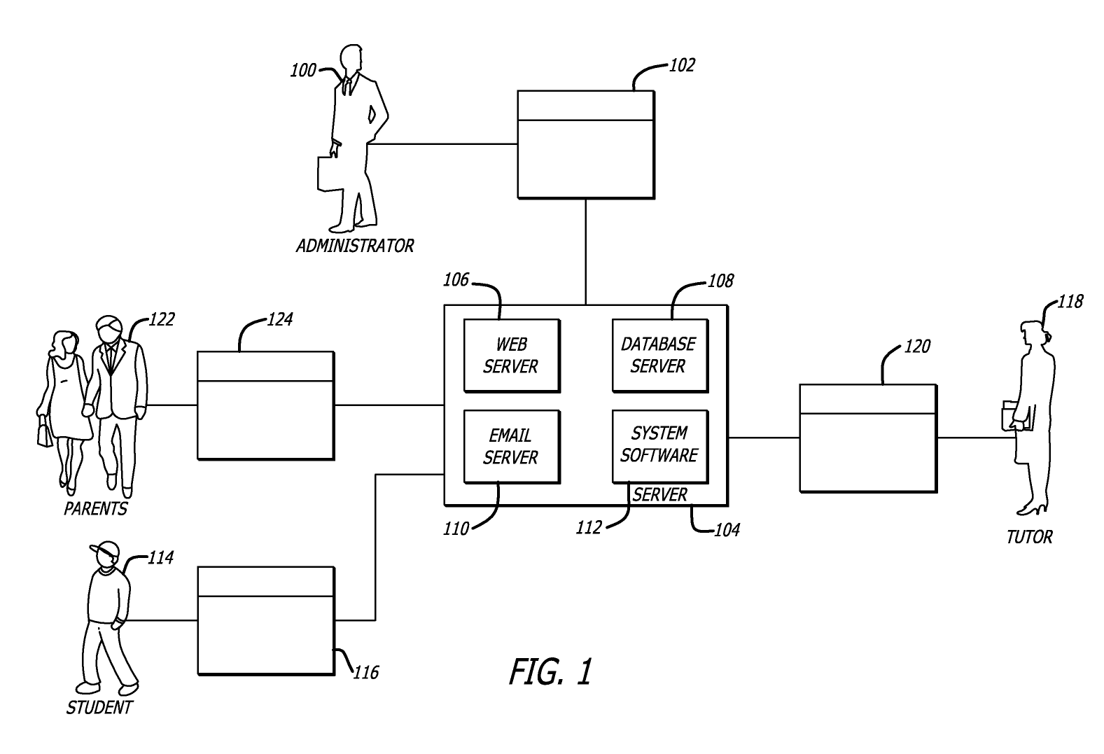

Turning first to FIG. 1, there is shown in a block diagram the various individuals and groups to whom the system and method of the present invention provides an interface and interaction. The primary individual in the group is an administrator 100. The administrator 100 is the individual (or more than one individual) who organizes the groups of people and who administers the system and method of the present invention.

The administrator 100 may be an organizer of a group of tutors, a tutor designated by a group of tutors to run the system or an individual retained to run the system and method of the present invention so as to act as an organizer. Alternatively, the administrator 100 may be a technician in charge of the system or a group of individuals acting collectively. It is to be understood that the administrator 100 may, in fact, be multiple people or that administrator 100 level access may be exercised by more than one person.

The next element is the administrator interface 102. In the preferred embodiment, this is a web page (as are all of the interfaces). It is to be understood, however, that this may, instead, be a graphical user interface for software installed on a computer or a command-line interface for a user logged into a server.

The administrator interface 102 includes all functionality relevant to or required by the administrator 100. It provides functionality such that the administrator 100 may add or remove other users, associate data and passwords with particular users, associate tutors with students, parents with students, send out invoices, notices to students and parents and perform numerous other functions. These functions are described with specificity in the figures that follow.

The next element is a server 104. In the server 104 of the preferred embodiment, several elements are provided. The first is web server software 106. This software 106 is capable of providing the web-based interfaces to each of the user categories. In the preferred embodiment the interfaces of the present invention are presented as web pages, varying according to the user that is logged into the system.

For example, should an administrator 100 login to the system, the web server software 106 will communicate with database server software 108 and will provide an interface comprised of elements designed for use in the management of the academic tutoring system. Alternatively, should a student 114 login to the system, only a subset of the elements provided to an administrator 100 will be provided in the interface, in addition to some elements designed especially for a student 114.

It is to be understood that this web server 106 software may, instead, be another form of login, such as a command line interface. Alternatively, a stand-alone software product may be provided to each of the users shown. In this embodiment, the software would provide its own protocols for connection to a remote server 104.

The web page or web server software 106 may not be needed in this embodiment. However, the stand alone software should be capable of providing access to a database server software 108 of some type in order to take advantage of the system of the present invention.

The second element within the server 104 is database server software 108. This software is capable of making, storing and maintaining records regarding students, teachers, tutors and administrators. Suitable database server software 108 includes SQL, Oracle® and various other database or similar systems.

It is to be understood that the database server software 108 need not actually be software that is typically employed as database server software 108. It may, alternatively, be an extensible markup language (XML) file and other software capable of writing directly to the XML file. It may, alternatively, be a text database or other similar file and file-writing structure.

The database server software 108 of the preferred embodiment is capable of reading from and writing to a database (or other data storage file). This database may be housed within the database server software 108, as a local file or remotely. The data that is written to this database includes student profiles and data, billing data, tutor profiles and data, login and password information, various data pertaining to the running of a tutoring service and numerous other types of data.

The software within the database server 108 in the preferred embodiment is capable of communication with the software web server 106. Thereby the web server software 106 may provide access to or means by which a user or administrator 100 may update, input or edit information contained within the database managed by the software of the database server 108.

It is further to be understood that a multiplicity of databases may be managed by the software of the database server 108. Alternatively, a single database may contain all relevant data.

It is further to be understood that the software of the database server 108 may not necessarily be a part of a single server 104. Instead it may be housed in a different location on different discrete physical servers. The grouping of these elements is indicative of the ability of these elements to act together and to communicate with one another.

Similarly, the software of the web server 106 may not actually be running or contained on a single server 104. The server 104 may instead be a multiplicity of servers or other similar hardware capable of acting as these elements.

The next element visible within the server 104 is the software of the email server 110. This server 110 is used to send out emails to parents 122, students 114 and tutors 116. It may also be used for other purposes beyond the scope of the present invention, such as marketing the tutoring or other services.

In the preferred embodiment the email server software 110 is used to send invoices, updates, reminders of checklists and checklist elements to students and tutors and various other tutoring-related emails. This email server software 110 may, in fact, be provided by a third party email web site or other means, but the software embodying the method of this invention is able to access this email server software 110 for the various described and other uses.

The functionality of these interfaces is provided by system software 112 running on a server 104. The interaction of data within the software of the database server 108, the creation and serving of web pages by the web server 106 and the emails sent out by the emails server 110 is also coordinated on the server 104 by system software 112. The system software 112 in conjunction or including the other elements shown as a part of the server 104 used to create and manage the various interfaces embodies the present invention.

The next element is the student 114 who uses the present invention. The student 114 is provided with a student interface 116 that communicates with the other system elements. The student 114 need not be a student involved in primary or secondary schooling. In fact, the student 114 may be an adult in college or graduate school who is undergoing tutoring.

The system and method of this invention are to be understood to be capable of servicing a multiplicity of students 114, parents 122 and tutors 116. A single student 114 is shown for purposes of example. The student 114 is provided with a student interface 116 that is distinct from the interface 102 provided to the administrator 100.

The student interface 116 is designed in such a way that it includes the capability to accept class schedules, homework assignments, deadlines, checklists, records of interactions with tutors, such as the tutor 118, and to produce, at least, a calendar or timeline of these events and elements. There are elements within the student interface 116, for example, that the student may not see or change, such as tutor comments or parental feedback or certain profile or billing data that has been set by an administrator 100.

The next element is a tutor 118. Here a single tutor 118 is shown for purposes of simplicity. It is to be understood that the system and method of this invention is capable of supporting a multiplicity of tutors 116 in their efforts to provide tutoring services to students 114.

As with the student 114, the tutor 118 is provided with a tutor interface 120 for use in effecting the system and method of the present invention. The tutor interface 120 is separate and different from the interface 102 provided to the administrator 100 and the student interface 116 provided to the student 114.

The tutor interface 120 includes the capability to review a multiplicity of students 114, to review and update scheduling for tutoring sessions, to email students, individually or collectively, to submit invoices to an administrator 100 for review and submission to parents 122, to provide feedback to students 114, provide feedback concerning students 114 to parents 122 and to review and set timelines, checklists, goals and other schedules or assignments for each of a tutor's students 114. These and other functions are provided within the tutor interface 120.

Parents 122 are also provided with a parent interface 124. The parents 122 are to be understood to be representative of a multiplicity of parents 122 who may be associated with particular students 114. It is also to be understood that parents 122 may be only a single parent, guardian, friend or other individual supervising a student 114. Only two parents 122 are shown for purpose of simplicity.

In the event that a student 114 is a college or graduate degree student, portions of the parents interface may also be provided to the student 114. For example, invoices and feedback regarding a tutoring session, not ordinarily supplied to a third grader may be provided directly to a student 114 who is of a certain age or level of maturity. Similarly, invoices for tutoring services may go directly to a student 114 of a certain age or maturity similarly to those provided to the parents 122 in the preferred embodiment.

The parent interface 124 is unique to the parents 122, providing information about the progress of tutoring sessions between a tutor 118 and an associated student 114. The parents may contact tutors, review tutor feedback regarding students, review summaries of tutoring sessions, request alternate tutors, review schedules, checklists, tests and subjects for an associated student 114 and perform other similar functions using the parent interface 124.

In the preferred embodiment, each of the interfaces such as interface 102, student interface 116, tutor interface 120 and parent interface 124 are web pages, varying dependent upon login identification as a student 114, parent 120, tutor 118 or administrator 100. In alternative embodiments, they may be stand-alone computer software or other interface types capable of connecting to a single server 104 or other system for providing the elements or a subset of the elements of server 104.

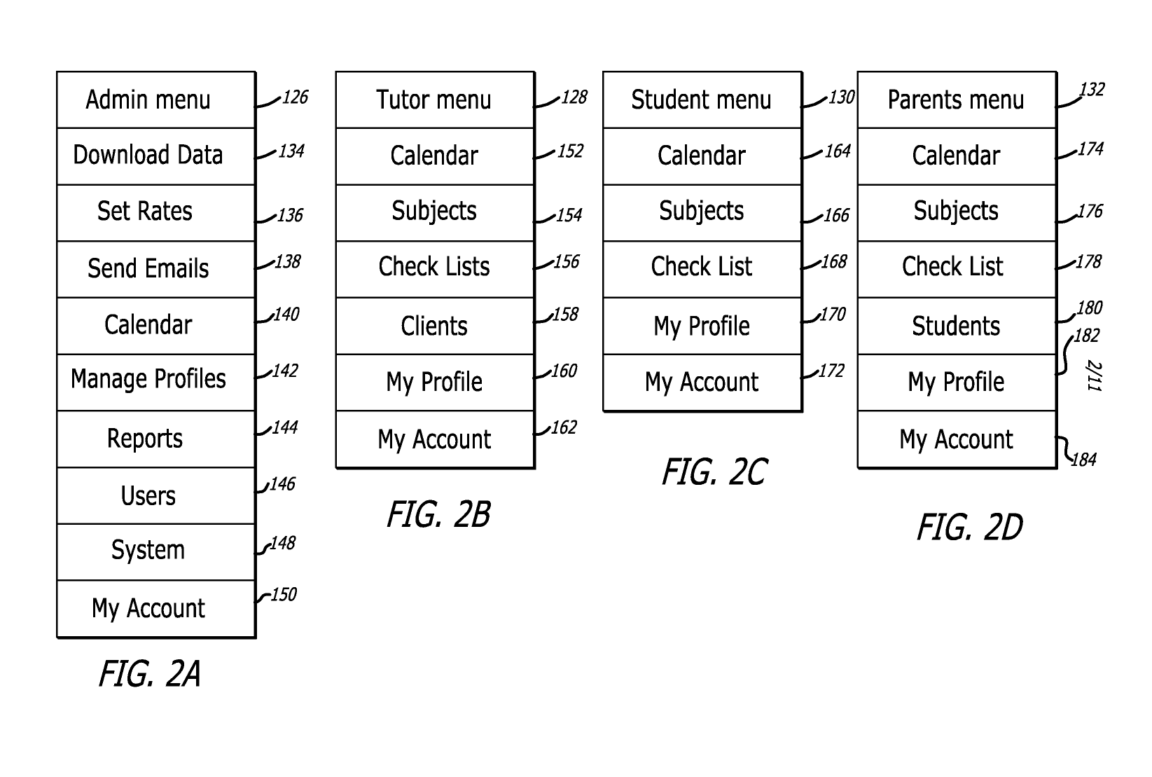

Referring now to FIG. 2, menus for the various interfaces, provided to each of the various user types. The first menu, FIG. 2A, is the administrator menu 126. The second menu, FIG. 2B, is the tutor menu 128. The third menu, FIG. 2C, is the student menu 130. The fourth menu, FIG. 2D, is the parent menu 132.

The administrator menu 126 is the menu displayed on the interface 102 (See FIG. 1) provided to the administrator 100. This administrator menu 126 displays “buttons” for each of the functions that may be activated or used by the administrator 100 of the preferred embodiment. It is to be understood that these buttons, representative of functions, are only exemplary and additional or fewer functions may be present in alternative embodiments of the invention.

The download data button 126 is used to download data pertaining to students, parents or tutors. For example, the administrator 100 may download to a spreadsheet, external database or other software or data file the information pertaining to a student, parent or tutor such as name, address, email address, phone numbers, classes being taken, students being tutored, sessions that occurred in the past, upcoming schedules of tutoring, upcoming tests and other data.

In the preferred embodiment, the data pertaining to a student may be updated by a student or a parent. Similarly, the data pertaining to a tutor may be updated by the tutor. The data pertaining to a parent may only be updated by a parent. Any data may be changed by an administrator 100.

As the data is updated, the administrator 100 is presented with an indicator on the download data screen that appears when the download data button 126 is selected. This indicator will alert the administrator 100 that new data has been entered and allow the administrator 100 to download it or otherwise store, save or print it.

In the preferred embodiment, the data is formatted in various ways such that the administrator 100 is able to download or print the data to be maintained in a hard-copy record. Additionally, the administrator 100 may download the data in a predetermined format for input into client-tracking software or this may be done automatically.

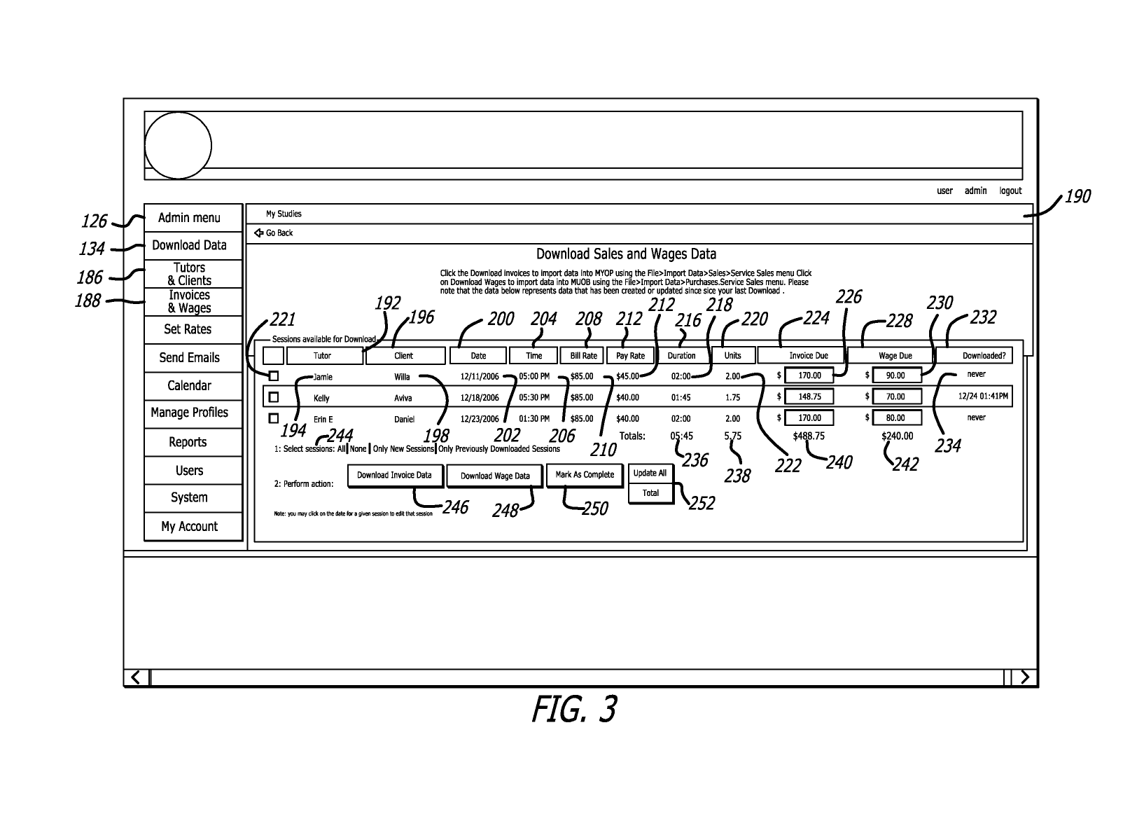

Alternatively, as is depicted more fully in FIG. 3, an administrator 100 may download billing data. A user of this data may subsequently import the data into accounting software to create mail invoices, to maintain proper books or to generate reports or other information from the data. Similarly, data pertaining to the rates charged by tutors may be downloaded in various formats using this download data button 126 and its sub-buttons.

The set rates button 136 is used to set the wage or hourly rates for various tutors. This button activates a screen wherein an administrator 100 may set a rate for each tutor involved in the system. The rate may also be set per tutor/per student. A tutor, for example, may tutor in multiple subjects and a particular subject may be valued at a greater rate. A student receiving tutoring in that subject may be billed at a higher rate than a student receiving tutoring in other less costly subjects.

The rates may also be set by default. If a previous rate has been set for a tutor and another student is added to that tutor's list of current students, then the rate most recently or most commonly assigned to that tutor may be automatically selected and assigned to the new student.

The send emails button 138 may be used to send emails to the students, tutors or parents. In the preferred embodiment its primary use is to send invoice emails to the parents (or students as described above). In the preferred embodiment, these emails also contain data input by the tutor regarding one or more tutoring sessions with the student.

In the preferred embodiment of the method of this invention, once a tutoring session has been completed, a tutor inputs information pertaining to the content of that session including any feedback regarding the student or the session. The feedback is submitted, along with a request for payment by the tutor for the session to the administrator 100.

The administrator 100 may review the request within the send emails button 138. The administrator 100 may also review the feedback or comments, editing or adding additional comments. These comments, feedback and invoice for the session are sent simultaneously. As will be described more fully below, the parents maintain access to the system of this invention, such that they may review feedback, grades, the past contents of and comments pertaining to tutoring sessions.

The parents, thus, receive invoices regarding the tutoring sessions simultaneously with detailed information about that session. This serves to keep the parents, tutors and students connected and communicating regarding the progress being made. It also fosters communications and connectedness between parents and tutors regarding a particular student's progress.

The send emails button 138 may be used to provide tutoring feedback regarding a student to a parent. In the preferred embodiment, these assignments, checklist items, feedback and similar items are sent automatically without intervention by the administrator 100.

The calendar button 140 may be used by the administrator 100 to view a master calendar for all tutoring sessions, all checklist elements, all subjects, all parent/tutor meetings and similar scheduled events. The master calendar of the preferred embodiment is dynamic such that the administrator 100 may select to see only tutoring sessions or may alternatively select to see tutoring sessions and checklist items.

Similarly, the administrator 100 may view the calendar of a particular student or tutor only. Student calendars contain checklist items with due dates, assignment due dates and tutoring sessions. Each element includes its date and other relevant information directly on the calendar. Tutor calendars contain tutoring sessions including time.

The manage profiles button 142 opens up a frame in the web browser in the preferred embodiment, whereby the administrator 100 may edit data pertaining to a student, parent or tutor. This data may be personal information such as contact information or may be tutoring session data. Any data input by the tutor, student or parent may be edited by the administrator 100. Similarly, an administrator 100 may simply view the profile data or may delete a particular profile, for example, if a tutor no longer works with the tutoring service.

The reports button 144 may be used to send or review reports regarding the tutoring sessions. These reports may be sent, as described above, along with an invoice. However, invoices are typically sent monthly or bi-monthly. Therefore, the reports button 144 exists to allow the administrator 100 to review reports regarding tutoring sessions that have been input by tutors and, if acceptable, forward them on to parents.

The reports may contain information regarding one or more tutoring sessions with a particular student or students (if the parents have more than one student being tutored). These reports are combined, in the preferred embodiment, into a single report as additional tutoring sessions occur before the reports are sent to parents.

The reports may then, be reviewed and sent, by email in the preferred embodiment, to the parents of a student regarding all comments and feedback for each tutoring sessions since the last report or invoice. The parents may respond to these comments, discuss the progress with the tutor or student or simply review for an understanding of the progress of each session.

The users button 146 is used to create and manage user accounts. This process may be carried out using any number of methods as are well-known in the art. For purposes of this invention, this process will only be described generally so as to not obscure the present invention.

The users button 146 may be used to create accounts for students, parents, tutors and other users with administrator (or related) access to the site. These user-levels determine the interface type seen by the user after login.

The administrator 100 may remove users, add users, edit user login information, such as usernames and, in the preferred embodiment, passwords. In alternative embodiments, passwords may not be editable by the administrator 100, but may only be “reset” by an administrator 100.

A peculiarity of the manage profiles button 142 and the users button 146 in the present invention is the capability to associate tutors with students and students with parents. This way, the parents of a particular student receive the invoices and reports related to a particular student and a tutor is able to schedule or reschedule tutoring sessions, view a student's schedule and to make comments on particular tutoring sessions with a student.

This process may be done by an administrator 100 after all the user accounts are created. Alternatively, as the user accounts are created, they may be associated during the creation or management process using the dynamic web page loaded when and administrator 100 selects the users button 146.

The system button 148 provides access to control software and system-related elements. These are technical and related to, for example, the email username or account to utilize in sending out email reports to parents. Additional examples are the database server software 108 file and tables to utilize in creating and storing data used by the present invention. Similarly, configuration data for the web server software 106 and various other system software 112 information are configured within the web page pane provided when this button is selected.

Finally, the “my account” button 150 is used by the administrator 100 to make any changes to the account and profile information of the administrator 100. This may also be used to add additional administrator accounts to the system of the present invention.

Referring now to FIG. 2B, the tutor menu 128 is the menu that is seen by a tutor 118 using the tutor interface 120 of the preferred embodiment. The buttons of the tutor menu 128 may be selected by the tutor 118 to view various aspects of the software embodying the system of the present invention. The software in the preferred embodiment, as described above, is implemented using a web-based methodology.

The calendar button 152 may be used by a tutor to view upcoming tutoring sessions. It is also dynamic such that a tutor 118 may view upcoming deadlines of various types, for example, checklists or assignments due, for one or more of the students currently being tutored by the tutor 118.

The subject button 154 may be used to review subjects being tutored by a particular tutor 118. In the preferred embodiment, these subjects are divided by student 114 and then by subject. A tutor 118 may review a subject in preparation for a tutoring session or to add additional suggested study for a student 114 prior to a tutoring session or in response to a tutoring session.

The checklists button 156 may be used to add, edit or delete a checklist. A checklist is a series of “to dos” for a student 114. In the preferred embodiment, a student 114 or tutor 118 can create a checklist for a particular class, subject, assignment or test. The tutor 118 may review any checklist, create a new checklist, delete a checklist or an item within a checklist for a student being tutored by that tutor 118.

The “clients” button 158 may be used to review the information pertaining to a particular student 114 or parents 122. For example, it may be used to gather contact information for a student, an email address or other information. It may be used to inform one or more clients that a tutor 118 must reschedule an upcoming tutoring session.

The “my profile” 160 button may be used by a tutor 118 to edit information pertaining to that tutor 118. For example, a tutor 118 may select that button to edit contact information or to set available times for tutoring sessions.

The “my account” button 162 may be used by a tutor 118 to reset a user password or to change the associated email address with their user account. These account management systems are well-known in the art.

Referring now to FIG. 2C, the student menu 130 is the menu presented to a student 114 upon login to the student interface 116. The student menu 130 appears substantially the same as the tutor menu 128, but does not include a clients button 158. The student 114, of course, does not have clients.

The student menu 130 first has a calendar button 164 for use in viewing the student's 114 calendar. The calendar of the preferred embodiment is dynamic, capable of showing all scheduled assignments, tests and checklists. It is, alternatively, capable of only showing a subset of the total scheduled events.

The “subjects” button 166 is used by the student to input subjects and to review assignments, checklists, milestone lists and various other events within a subject. The student 114 may also review the subjects pane of the web page to see past goals on tests, assignments and other tutoring goals in order to determine the extent to which goals have been met. The student may also review tutor feedback on various subjects in this pane.

The “check lists” button 168 is used by the student to input, edit or “check off” checklists and checklist elements. As discussed above, check lists are steps that define a pathway by which a student 114 may tackle an assignment, series of assignments, a difficult class or laboratory assignment. The student 114 or tutor 118 may delineate steps along the way and organize them as a check list.

The student 114 may edit the checklists, create new checklists, review checklists or input data pertaining to a checklist using the pane created using this button. A tutor may also, in the preferred embodiment, edit, create or “check off” elements or entire checklists on behalf of one of the students they tutor.

The “my profile” button 170 may be used, as described with reference to the tutor menu 128, to update contact information, telephone numbers and various other profile information. For the students 114, the profile may also contain grade level, age and other information that may be useful to potential tutors 118.

The “my account” button 172 is used to update passwords and email addresses associated with the student's 112 account. These systems and internet web page login and user accounts are well known in the art.

The parent menu 132 is very similar to the student menu 130. The parent menu 132 is the menu presented to parents 122 when they login to the system software 112. Parents 122 are presented with the parents interface 124 including the parent menu 132.

The “calendar” button 174 makes available to parents 122 a calendar of scheduled events as with the student calendar. If the parents 122 are associated with more than one student 114, then the calendar is capable of displaying each scheduled event, homework assignment, test or other tutoring-related event that each of the associated students has.

This calendar, as with the previous calendars, is dynamic. Capable of showing all events or any requested subset. For parents, as an additional example, the calendar may display only events associated with a particular student in addition to the dynamics of the calendar described with reference to the tutor 118 and the student 114.

The “subjects” button 176, as above, may be used to view the subjects being taken or tutored by the students 114 associated with the parents 122. If there are multiple students 114, the parent will first be asked to select the appropriate student 114, then they may select any one of the subjects listed for that student 114 to view schedules, tutor comments, upcoming tests, milestones and other events.

The “check lists” button 178, as above, may be used to view the checklists associated with a particular student 114. Again, if there are multiple students 114 associated with a particular set of parents 122, then the parents 122 may select the student 114 first, then view any check lists created by or for that student 114.

In the preferred embodiment, the parents may also review the checklists and, if desired, make changes, add to, edit or delete checklists or checklist items. In alternative embodiments, the parents 122 may not make changes to any student 114 or tutor 118 created check lists.

The “students” button 180, provides the parents with functionality similar to that of the clients button 158 provided to tutors 118. The students button 180 presents the parents with a view of each of the students 114 associated with those parents 122 and allows the parents 122 to view and edit profile information and to review schedules and various other information about an associated student 114.

The “my profile” button 182, similar to the same button in other menus, allows parents 122 to input, update or remove contact information and other relevant profile data. The profile may subsequently be viewed and used by the tutor 118 or administrator 100 to contact the parents.

The “my account” button 184 may be used, as is well known in the art, to update account settings such as username, email addresses and to select a number of settings regarding the layout and presentation of the parent interface 124. These systems are well-known in the prior art and will not be described in detail so as to not cloud the present invention unnecessarily.

Referring now to FIG. 3, a depiction of the administrator menu 126 with the download data button 134 selected is shown. The two submenus items are also shown in this figure. The tutors and clients button 186 is used to view a screen useful for downloading data pertaining to tutors and clients.

As is true of all of the buttons in this administrator menu 126, this interface is only visible and accessible to an administrator 100. The students 114, tutors 118 and parents 122 are each presented with a different interface and menu, each granting various levels of access to the system software 112 of the present invention.

To begin using the system and method of the present invention, the user may login to an account using a username and password, as is well-known in the art. Based upon the username and password given, access is granted to one of the various levels of access to the system software 112 and an appropriate level of access is granted.

For example, in the tutors and clients data is maintained, in the preferred embodiment, in a list of customers with checkboxes such that one or more client data may be viewed or downloaded simultaneously. In the preferred embodiment, the administrator 100 may download the data in a single data file format such that it may be imported into a separate program, such as a contact management software or an accounting software.

In the preferred embodiment, the administrator 100 may download data pertaining to students, parents and tutors for importing into separate programs or simply view the data, selecting one or more to be downloaded.

The invoices and wages button 188 is shown as selected. As with each of the buttons described with reference to FIG. 2 and in following figures, selecting this button 188 causes a web page pane to load. In alternative embodiments, it may activate a new graphical user interface in a stand alone software product.

The web page pane 190 depicts a number of sessions available for download. These sessions are sessions for which an invoice has been submitted by the tutor 118, but which has not yet been forwarded on to the parents 122. This portion of the administrator interface 102 provides means by which the administrator can review and download invoices for use, for example, with external accounting software.

In the preferred embodiment, at the end of a tutoring session, a tutor fills out a report as to the activities done during the session, providing comments and feedback and then submits them along with a listing of the total time spent during the session. This data is stored in the database and accessible to the system software 112. It may be downloaded here by the administrator 100 for other uses, such as accounting.

The first visible element is the tutor column 192. The tutor's name who has submitted a particular tutoring session for billing is visible here. For example, the name Jamie 194 is visible in the tutor column 192. In the preferred embodiment, last names will be included. In alternative embodiments, unique identification numbers or other elements may also be included for more simple management of billing.

The client column 196 is used to show the client for which the billing invoice is being submitted by the tutor 118. In this case, the first client is Willa 198. The date column 200 is used to show the date at which the session took place. The session data 202 shown is Dec. 11, 2006 or Dec. 11, 2006.

The time column 204 is used to show the time at which the session took place. The session time 206 in this example was 05:00 PM. The bill rate column 208 is used to show the rate at which the client is billed. The bill rate 210 is $85.00 for this client. The pay rate column 212 shows the pay rate 214 at which the tutor 118 is paid. The pay rate 214 shown in the present example is $45.00.

The duration column 216 is used to display the duration 218 of the tutoring session. In this example, the tutoring session's duration 218 was 02:00, meaning 2 hours. The units column 224 is used to display the number of billable units 222 for this time. The billable units 222 in this example are 2.00 units, representing two full hours.

The invoice due column 224 shows the invoice due amount 226 for this client. The invoice due amount 226 in this example is $170.00. The wage due column 228 shows the wages due 230 to a particular tutor. In this example the wages due are $90.00.

As can be seen, the invoice due amount 226 may be edited as it is a textbox. This allows the administrator 100 to input higher or lower invoice due amounts as he or she wishes. Similarly, the wages due 230 may also be edited by an administrator 100.

The final column, the downloaded? column 232 is used to display to the administrator 100 the status 234, meaning, whether or not this data has been previously downloaded for use elsewhere, for example, in accounting software. The present example status 234 is “never,” meaning that this data has not ever been downloaded before.

The preferred embodiment, as can be seen, also totals the various columns. The duration column 216 has a duration total 236 of 05:45, meaning five hours, forty-five minutes. The units column 220 has a units total 238 of 5.75, meaning five and 75/100ths of a unit.

The invoice due column 224 has an invoice due total 240 as well. In this example, the invoice due total 240 is $488.75. The wage due column 228 has a wage due total 242 of $240.00.

The sessions may be selected for download in several forms. Each session may be selected individually by “clicking” the selector checkbox 221. Similar methodologies for selecting one or more of a group of elements are known in the art. Alternatively, the user may use one of the select sessions methods 244 shown, selecting all, none, new sessions, only previously downloaded sessions. These select session methods 224 act as macros, selecting appropriate sessions automatically.

Once the desired sessions have been selected, a user may select the download invoice data button 246 to download the data that may be used to create invoices, for example, using external accounting software. This data will not include wage data. The download wage data button 248 may also be used to download only wage data. This data will not include invoice data.

The mark as complete 250 button may be used to “mark” a particular session or sessions as having been downloaded already. The update all totals button 252 may be used to update totals in the event that the administrator 100 has chosen to update the invoice or wage data for a particular session.

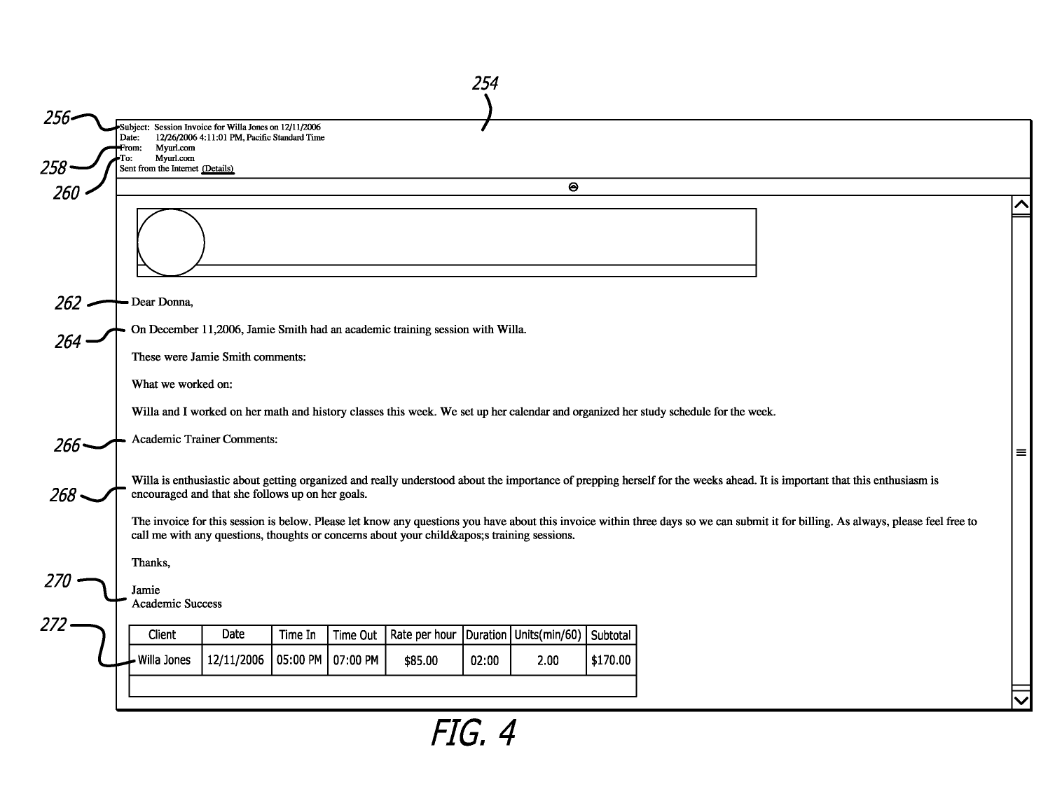

Referring next to FIG. 4, a depiction of an email sent using the web pane that is activated using the send emails button 138 is shown. The send emails button 138 activates a web pane such that a user may send emails to the client. The web pane is designed in such a way as to automatically include billing, comments, tutoring session summaries and tutor feedback. The email may be sent without adding any additional comments from the administrator 100 but provides that comments may be input. Additionally, sections, such as the billing information, may be left out at the behest of the administrator 100.

In the preferred embodiment, there is also a running list of the number of emails sent to a parent 118 or other individual. Similarly, there is a date and time of the most recent email sent. The administrator 100 may review emails prior to their being sent, adding their own comments or changes.

Email pane 254 shows an example email sent using the send emails button 238 and the window pane activated by this button 238. Emailing forms are well-known in the prior art. However, their use to combine tutor interaction, invoices for academic tutoring and comments regarding each relevant tutoring session has not been seen in the prior art.

The subject 256 of the email is automatically created for the administrator 100. The subject, for example, is “session invoice for Willa on Dec. 11, 2006.” This subject is descriptive of the contents of the email. The from box 258 demonstrates that it was sent from “billing@my-academic-success.com,” an example email address. Similar generic-style email addresses may be used or personal email address, for example, from the administrator 100 or from the tutors 118 may be used.

The to box 260 is automatically addressed to a user of the system and method, typically the parents 122. As has been described above, occasionally, this may be the student 114 themselves or other individual paying for or monitoring the service. Alternatively, it may be sent to multiple parties, automatically.

The salutation 262 is automatically generated, using the name(s) of the appropriate parties and the date 264 is automatically incorporated, describing the date of the session. Similarly, the session summary 266 entered by a tutor 118 is automatically incorporated (after having been reviewed by the administrator 100). The comments 268 are also incorporated (after having been reviewed by the administrator 100.

The signature block 270 is automatically created, using the name of the tutor 118 or the administrator 100, depending on the embodiment of the invention. The invoice data 272 is attached, if desired, to the bottom of the email for review by the client prior to payment.

This email method increases the speed at which a tutoring service administrator may review invoices and comments, submitted by each tutor, review the contents of those invoices and comments and quickly send them out in a format suitable for parents 122. This is an improvement, provided by the inclusion of a multiplicity of elements into a single software package.

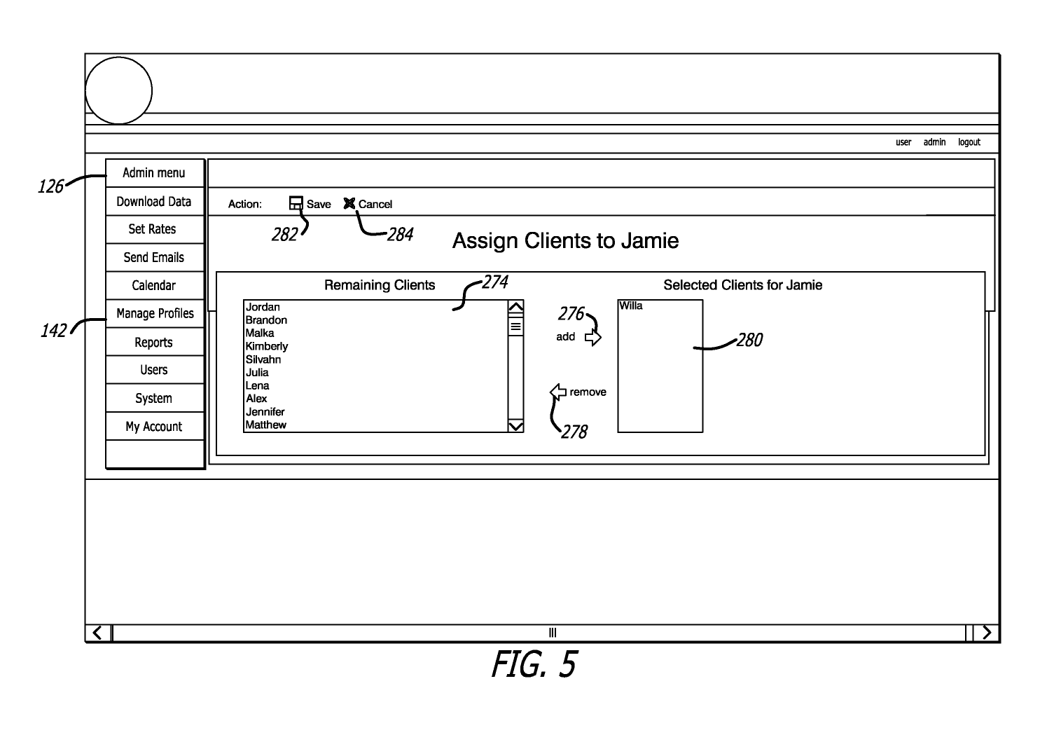

Referring now to FIG. 5, a portion of the manage profiles web pane is depicted. As can be seen, in the administrator menu 126, the manage profiles button 274 is selected. In the preferred embodiment, the manage profiles button 274 contains three sub-buttons. One is entitled “tutor profiles,” another is entitled “client profiles” and the last is entitled “parent profiles.”

These buttons provide access to web pages embodying means by which an administrator 100 may create new profiles in each of these group types (including names, contact information and similar information) and whereby the administrator 100 may edit or delete each of these profile types.

FIG. 5 further depicts a subscreen of the tutor profiles web pane, whereby an administrator 100 may assign clients to a particular tutor. The administrator may navigate the site to this page and is then presented with a client listing 274. The clients listed in the client listing 274 are students 114 which currently do not have a tutor 118.

The administrator may then assign a student 114 to a tutor 118 by means of the add button 276. The student 114 is then added to the tutor's 118 list of students. The student 114 may be removed from the list by the act of selecting the remove button 278. The tutor's client list 280 depicts the students which will be added to the tutor's clients once the save button 282 is selected. Alternatively, the cancel button 282 may be selected and any students selected will not be added to the tutor's clients.

Similar means are provided within the client profiles subscreen. In this subscreen, parents 122 may be assigned to a particular client (student 114) in much the same way by the administrator 100. Thereby the email sending and tutor comments are directed, from that point forward, to the appropriate parents 122.

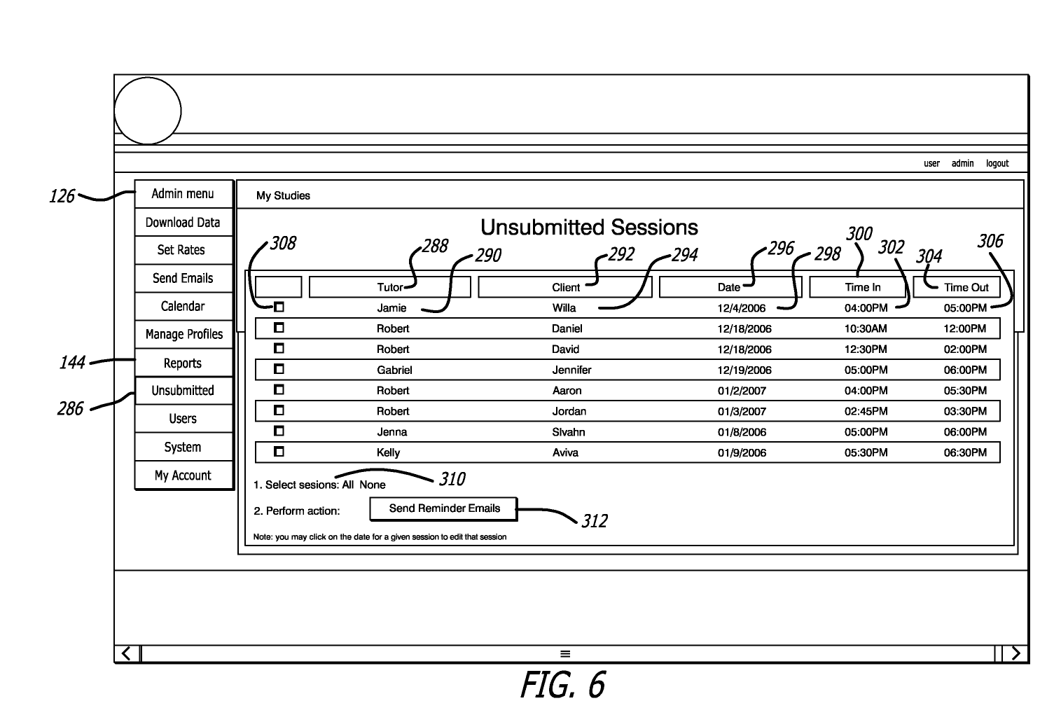

Referring next to FIG. 6, a web pane used for reports is shown. The reports button 144 has one sub-button, the unsubmitted button 286. Clicking on the reports button allows the administrator to review, per client, comments, reports concerning tutoring sessions and feedback submitted by a tutor 118. These reports are archived here for review after they have been sent to the parents 122. Additionally, unsent reports may be reviewed prior to their being sent out in invoices or by other means.

The unsubmitted button 286 opens a web pane as depicted in FIG. 6 for use in reviewing sessions which have occurred but for which a tutor 118 has not yet submitted comments or a report regarding that session. This pane provides an easy interface whereby an administrator 100 can review the sessions that have occurred without reports being generated and thereafter send emails to the tutors reminding them to submit reports concerning the sessions.

The tutor column 288 includes the tutor 290 (Jamie in this example) who led a tutoring session. The client column 292 includes the student 294 (Willa in this example) for whom the session was conducted. The date column 296 include the date 298 in this case Dec. 4, 2006 or Dec. 4, 2006 on which a session occurred. The time in column 300 showing the time in 302 of 04:00 PM and the time out column 304 showing the time out 306 of 05:00 PM demonstrate that this session lasted one hour.

An administrator 100 may select individual session using the checkboxes, such as checkbox 308. Alternatively, the administrator 100 may, as above, select using one of the select session 310 means. Once the sessions have been selected, an administrator may select the send reminder emails button 312 to send out an automatic email to the tutors, listing the sessions for which they have not submitted reports and requesting reports for those sessions.

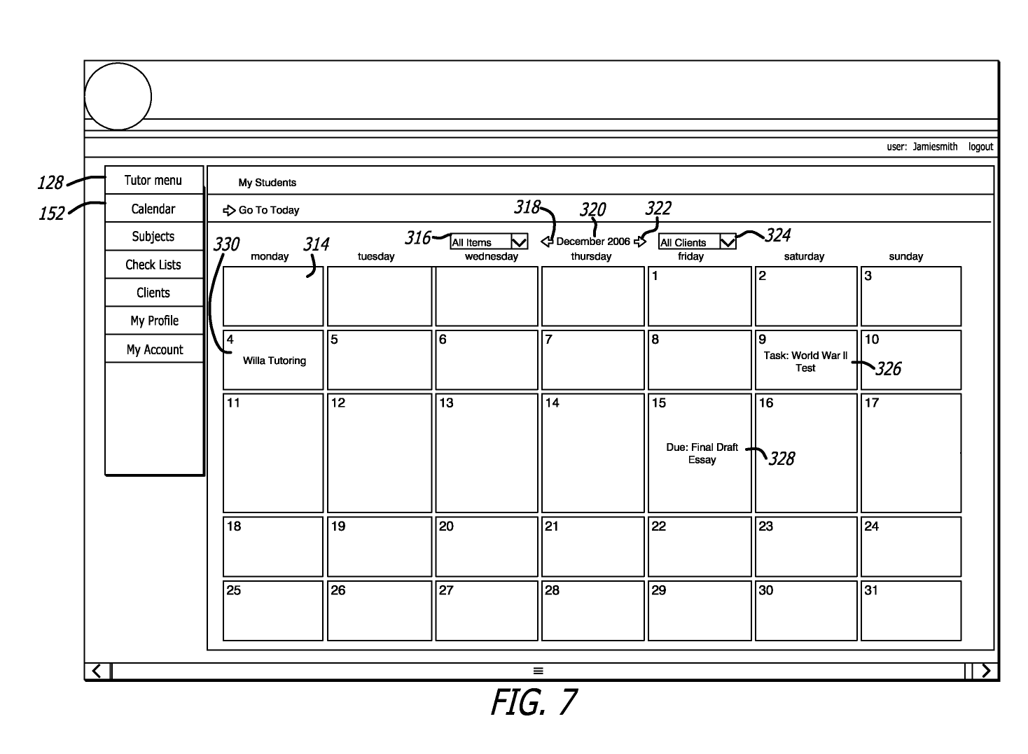

Referring next to FIG. 7, the first portions of the tutor interface 120 are shown. The tutor menu 128 is shown, including a “calendar” button 152. A calendar 314 depicts various time-sensitive elements that are specific to a particular tutor 118. As described above, the calendar 314 is dynamic. The elements being displayed may be changed, while not changing the events themselves or their scheduling.

A display selector 316 is currently set to “All items.” This selector 316 may be set to checklist items, tests, projects due, tutoring sessions or any number of project types. When the display selector 316 is set to “all items,” it displays every project type. When it is set to other types, only those types of items are displayed. So, for example, if it is set to tutoring sessions, then only tutoring sessions for the currently logged-in tutor will be shown in the calendar 314.

A “back” button 318 allows a user to go back one month. A forward button 322 allows the user to go forward one month. A month display 320 (displaying December 2006) is also shown at the top of the calendar.

Similarly to the display selector 316, a client selector 324 allows a tutor 118 to view all of the elements related to any client or alternatively to select only one of the clients. Currently, the display includes all clients, as is listed in client selector 324. However, a tutor 118 may select to view a single client's upcoming events and due dates instead.

Examples of things stored in the calendar 314 include tasks. Tasks, such as an example task 326, are things that must be accomplished by a particular day. These may be input, as described above, by the student, teacher or parent. Due dates, such as a due date 328, may also be shown on the calendar. These are dates in which school assignments are due and for which milestones may be set. Another example is a tutoring session. A tutoring session, such as tutoring session 330, are times during which a tutoring session will be taking place.

The master calendar, containing all elements for all clients may be seen by the administrator 100, as described above (and as seen in calendar button 140. Its appearance is similar to calendar 314, but contains access to every event, project or due date input into the calendar of any student or tutor. It is, also, dynamic such that only subsets of the entire calendar may be viewed as well.

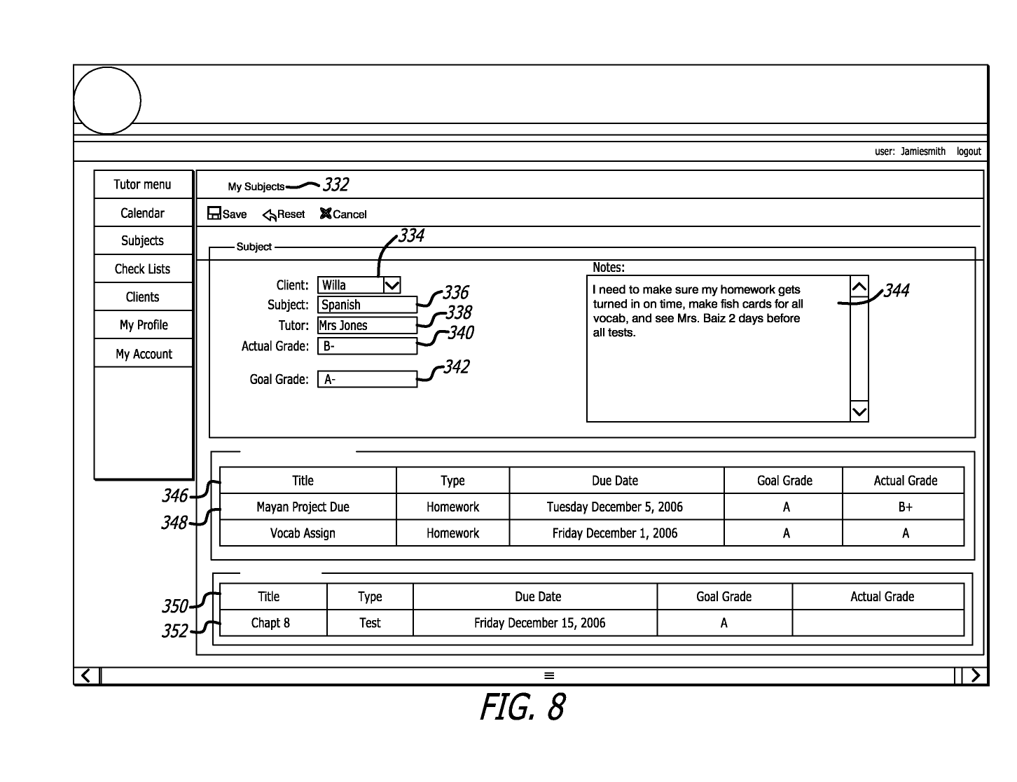

Referring now to FIG. 8 a “my subjects” pane 332 is shown. The subjects button 154 is selected by the tutor 118 and this brings up the my subjects pane 332. A client dropdown 334 currently displays “Willa” one of the clients of this tutor 118. In the preferred embodiment, it may be used to select any client.

The my subjects pane 332 depicted is the second pane after a tutor selects the subjects button 154 in the tutor menu 128. The first pane allows the user to select the student, then the subject. The tutor or student may also add a new subject using similar methodology.

The my subjects pane 332 is used to input a subject in a subject box 336, to input the teacher's name in a teacher box 338, the actual grade in a grade box 340 and the goal grade in a goal grade box 342. The student or tutor may also make a note regarding the class generally in a note textbox 344.

Once the user has input the data pertaining to a subject, a “save” button 354 may be used to save the subject. A “reset” button 356 may be used to clear all of the textboxes. A “cancel” button 358 may be used to return to the subject selection pane.

Once a subject (or series of subjects) is created, the user may create assignments, tests and other events and assign them, using the system of the present invention, to particular subjects.

For example, there are assignments depicted in an assignments from calendar table 346 including an example Mayan project due assignment 348. Similarly, tests may be associated with a class, such as Spanish class in this example, wherein there is a test from a calendar table 350 including a chapter 8 test 352. All important events and information related to those events may be seen by a tutor, student or parent using the system and method of this invention on this or a similar pane.

One of the means by which this association is accomplished is the check lists button 156 on the tutor menu 128. The tutor may create a checklist using the pane opened using this button. The client may be selected using a client selector 354. In this example, the client is, again, Willa. The subject (entered using the subjects pane) may be selected using a subject selector 356.

The title of the element to be added may be entered in a title box 358. The type of event or assignment, such as test, homework, review, study, teacher meeting and the like may be selected using the type selector 360. The date of the event may be input using a date text box 362. At this time the tutor 118 may view the calendar using a “view calendar” button 364, such that he (or she) may see if there is available time.

The actual grade may be input (after the event has occurred and if a grade is given) using an actual grade text box 366. The goal grade may be input using a goal grade text box 368 and a color may be selected using a color selector 370 whereby the assignment type will appear in that color on the previously-seen calendar. The user may also input notes regarding the assignment in a notes text box 372.

Each event may also have a number of milestones, each having its own due date. A select milestone column allows a user to select multiple milestones using a milestone checkbox 382 associated with each milestone. A date column 376 shows the date upon which a milestone should be completed, as input using a milestone date text box 384. It also allows one to view the calendar using the view calendar button 386.

A milestone description column 378 allows a user to input a milestone description into a milestone description text box 388. A completed column 380 allows a tutor 118 to select a completed checkbox 390 associated with a particular milestone, thereby indicating that it has been completed.

The tutor may also add a milestone, using an “add a milestone” button 392 and delete selected milestones, using a “delete selected milestones” button 394. These enable a tutor 118 to control the milestones set for a student. In the preferred embodiment, a student may view these and may also be allowed to edit, add or delete milestones as well. Of course, the parents 122 are able to review all subjects and milestones and such for a particular associated student 114.

Once the tutor 118 has completed adding the check list element, they may save the check list element using a “save” button 396. The tutor 118 may also reset each of the text boxes using a “reset” button 398. The entire process may be cancelled using the cancel button 400. Once the event is saved, using a “save” button 396, the event, including all milestones, is posted on the calendar of the student 114 and associated tutor 118.

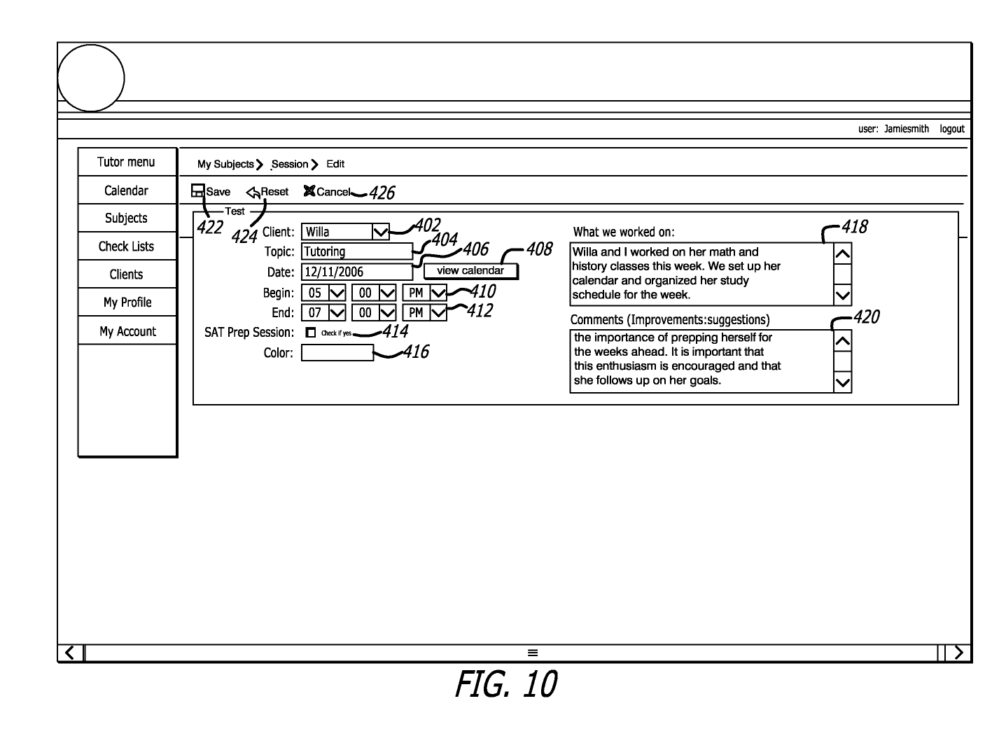

Referring next to FIG. 10, the clients button 158 has been selected in the tutor menu 128. The tutor 118 has elected to create a report regarding a session. At other times, the tutor 118 may make a report for general feedback or other reasons. These reports, as has been seen previously, are sent to the parents 122 along with an invoice or alone.

The first dropdown box in the report generation web page pane, which is available when a tutor 118 selects the clients button 158, is a client selector 402. The tutor may select any one of a number of clients (students 114) that are currently receiving tutoring from that tutor 118.

The topic of the report may also be input using a topic text box 404. Data may be input using a date text box 406 and the calendar for this student 114 may be viewed using a “view calendar” button 408. The session begin time may be selected using the begin dropdown menus 410. The session end time may also be selected using the end dropdown menus 412.

A SAT prep checkbox 414 may be checked to indicate that this session includes SAT testing preparation. In alternative embodiments, additional “session type” checkboxes may be provided. Finally, a tutor 118 may select the color using a color selector 416. This allows the tutor 118 to set the color of the event appearing on the student's 114 calendar.

The parts of the report generation web page pane that are most useful to parents 122 are a “what we worked on” text box 418 and a comments text box 420. These two text boxes are used to input details about the tutoring session (or other topic as input by the tutor 118) and comments for improvement, respectively.

Once the tutor 118 has filled in the report details, the tutor 118 may submit the report using a “save” button 422. The tutor 118 my reset all the data fields in the report generation web page pane using a “reset” button 424 or may cancel the creation of a report using a “cancel” button 426.

The interfaces provided to the student 114 and parents 122 are remarkably similar to that of the tutor. The student 114 and parents 122 interfaces do not include the ability to create reports. They, however, as seen in FIG. 2, include the capability to create checklists, to input or edit subjects, to edit or create milestones, to review reports from tutors (for the parents 122) and other similar functionality.

The student 114 is generally capable of reviewing classes, goals, tutor comments, reviewing the calendar and seeing and creating goals and milestones so that he (or she) may complete them. The parents 122 are generally capable of reviewing the goals of the student, the calendar, the results of tutoring sessions, the grades achieved and input by students for particular tests, assignments and events, reviewing reports from tutors, receiving and reviewing invoices for services and in the preferred embodiment, editing milestones and goals as well.

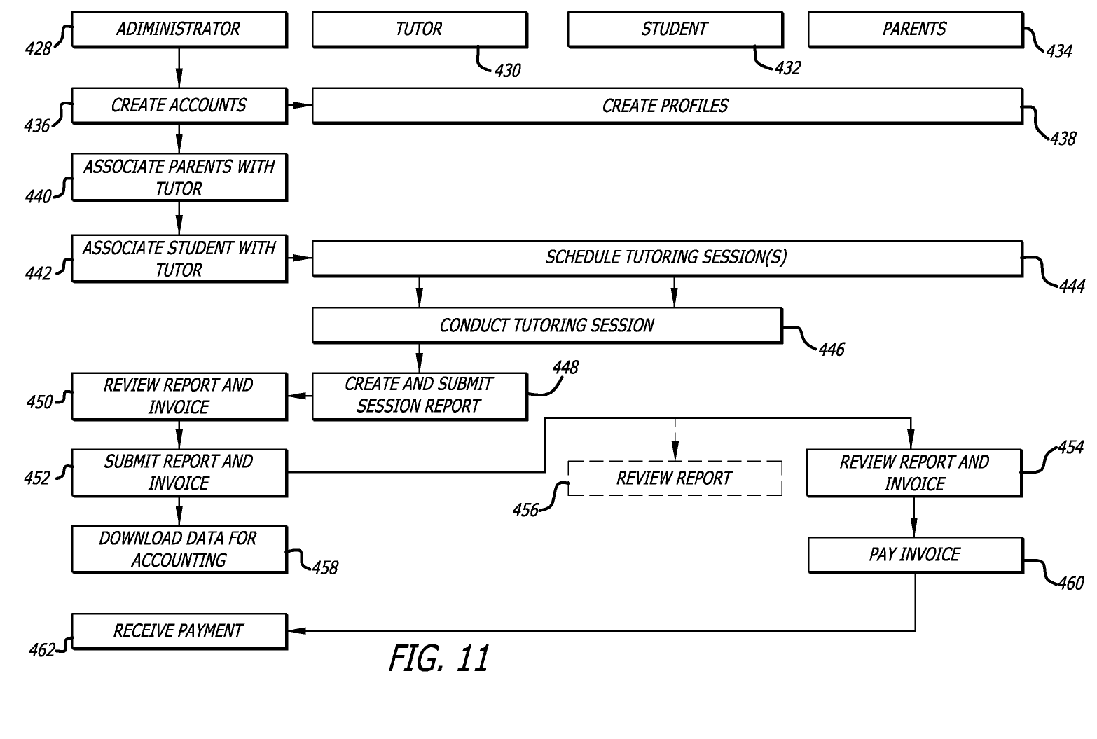

The foregoing may be better understood by way of an example. Referring now to FIG. 11, a typical flowchart of the process of the present invention is shown. It is to be understood that there are other alternative processes, additional or fewer branches in the process flowchart and other embodiments which may be used. However, FIG. 11 provides a useful example of a typical process.

The top row of elements are the individual interfaces used and, by reference, the individuals using those interfaces. Each column in the subsequent rows refers to actions taken by the individual and interface in the top row of the column.

An administrator 428 may be the administrator 100 from FIG. 1, using the administrator interface 102. Tutor 430 may be the tutor 118 from FIG. 1, using the tutor interface 120. Student 432 may be the student 114 from FIG. 1, using the student interface 116. Parents 434 may be the parents 122 from FIG. 1, using the parents interface 124.

The first step in this process is a create accounts step 436. In the create accounts step 436, the administrator 428 creates usernames and default passwords for each user, typically for the tutor 430, student 432 and parents 434. The tutor 430, the student 432 and the parents 434 then create profiles 438.

The created profiles may be edited by each of their respective creators or by the administrator 428. The administrator 428 then associates parents 434 with students 440. In this step, the parents of a particular student 432 are identified as belonging to a particular group of parents 434.

The administrator 428 then associates a student 432 with a tutor 430 in the associate student with tutor step 442. Once a student 432 has been associated with a tutor 430, the parents 434, student 432 and tutor 430 may schedule tutoring session(s) 444.

In the preferred embodiment the schedule tutoring sessions(s) step 444 is organized using the calendars described above. The tutor 430 inputs available times for tutoring. The student 432 and parents 434 review available times and select one of the available times to schedule a tutoring session. The parents 434 and student 432 may use the web site to request the session.

A conduct tutoring session step 446 is then completed by the tutor 430 and the student 432 together. The tutor 430 then completes a create and submit session report 448, summarizing the tutoring session. Through the act of creating the session report, the invoice of the session is also created utilizing wage data and billing rate data previously entered by the administrator 428. The graphical display for this report creation is shown in FIG. 10.

The administrator 428 then completes the review report and invoice step 450. In this step 450, the administrator 428 reviews the session report created by the tutor 430 and makes any changes necessary. The administrator 428 may also review the invoices, altering billing invoices as necessary.

The administrator 428 then completes a submit report and invoice step 452, whereby the invoice(s) and report(s) are emailed (in the preferred embodiment) automatically to the email address(es) of the parent or parents 434 of the associated student(s) 432. Each email contains the associated session report(s) as drafted by the tutor 430, edited by the administrator 428 and includes the invoice(s) for the services. An email resulting from the completion of this step in the preferred embodiment is shown in FIG. 4.

The parents 434 may then review the session report and invoice 454. In alternative embodiments, as described above, the student may also review the report 456. The parents 434 may then pay the invoice 460.

Substantially concurrently, the administrator 428 is able to use the administrators interface 102 to download the data for accounting 458, as shown in FIG. 3. Finally, the administrator 428 receives payment 462 from the parents 434 for the tutoring session.

It is to be understood that the student 432 may substitute in place of the parents 434 in various situations or there may be no parents 434 involved in some situations. Alternatively, the administrator 428 may also be the tutor 430, taking on both roles simultaneously or at different times sharing the roles of both.

It is also to be understood that the system of the present invention may be used for other discrete methodologies, while not departing from the above described system and method generally. The system and method of the present invention make the jobs of tutors and administrators of tutoring businesses simpler and more easily managed.

Accordingly, a system and method for academic tutoring has been described. It is to be understood that the foregoing description has been made with respect to specific embodiments thereof for illustrative purposes only. The overall spirit and scope of the present invention is limited only by the following claims, as defined in the foregoing description.

What is claimed is:

1. A system for enabling academic tutoring comprising:
first interface means for providing access to the system for a tutor;
second interface means for providing access to the system for a student;
database server software for storing data pertaining to the academic tutoring; and
system software means, connected to said first and second interface means and to said database server software, for coordinating interaction between said first and second interface means and said database server software such that said data pertaining to the academic tutoring may be created, modified and amended.

2. The system of claim 1 further comprising:
web server means, connected to said system software, for providing access to said first and second interface means to users in the form at least one web page.

3. The system of claim 1 further comprising:
email server means, connected to said system software, for transmitting data pertaining to the academic tutoring from said database server to preselected recipients.

4. A system for enabling academic tutoring comprising
first interface means for providing tutor access to the system;
second interface means for providing student access to the system;
third interface means for providing administrator access to the system;
fourth interface means for providing parent access to the system;
system software, connected to said first, second, third and fourth interface means, to said database server, said email server and said connectivity enabling means for coordinating interaction among said first, second, third and fourth interface means and said database server software such that said data pertaining to the academic tutoring may be amended;
a database server, connected to said system software, for storing academic tutoring data;
an email server, connected to said system software, for sending emails to users of said first, second, third and fourth interface means, including said data pertaining to the academic tutoring from said database server; and
connectivity enabling means, connected to said system software, for providing access to users of said first, second, third and fourth interface means.

5. The system of claim 4 wherein said connectivity enabling means is a web server, connected to said system software, for providing said first, second, third and fourth interface means to users in the form at least one web page.

6. The system of claim 4 wherein said first interface means comprises a series of web pages provided to said tutor, whereby said tutor may input comments regarding tutoring sessions between said tutor and a student.

7. The system of claim 4 wherein said second interface means comprises a series of web pages, provided to a student, whereby said student may input and review upcoming academic events.

8. The system of claim 4 wherein said third interface means comprises a series of web pages provided to said administrator, whereby said administrator may review and coordinate tutoring sessions between a student and a tutor.

9. The system of claim 4 wherein said fourth interface means comprises a series of web pages provided to parents, whereby said parents may review comments regarding a recent tutoring session between a tutor and a related student.

10. A method of academic tutoring, comprising the steps of:
storing at least one academic event in a database;
providing access to said at least one academic event for at least one student and one tutor;
storing feedback regarding tutoring sessions as input by said tutor; and
sending an email to said student including the feedback.

11. The method of claim 10 further comprising the additional initial steps of:
creating a first user account for said at least one student;
creating a second user account for said at least one tutor;
creating a profile for said at least one student and one tutor; and
assigning said at least one tutor to said at least one student to act as an academic tutor.

12. The method of claim 10 further comprising the additional steps of:
enabling review of said feedback, prior to said sending step; and
including an invoice along with said email.

13. A method of academic tutoring comprising the steps of:
creating user accounts for a tutor and student;
providing access to a web interface for said tutor and said student;
scheduling at least one tutoring session involving said tutor and said student;
conducting said at least one tutoring session;
creating feedback from said tutor regarding said at least one tutoring session;
reviewing said feedback; and
sending an email including said feedback and an invoice for said tutoring session.

14. The method of claim 13 further comprising the additional steps of:
enabling the storage of academic events using said web interface;
storing at least one academic event using said web interface; and
providing a calendar, accessible to at least said student and said tutor, as a part of said web interface, for viewing said at least one academic event.

15. The method of claim 13 further comprising the additional steps of:
creating billing data, based upon a pre-determined billing rate, upon the completion of said feedback; and
providing means to download said billing data to an external source in the form of a data file.
